(19) United States
(12) Patent Application Publication
(10) Pub. No.: US 2017/0331744 A1
(43) Pub. Date: Nov. 16, 2017

(54) COMBINED DELAY AND LOSS BASED CONGESTION CONTROL ALGORITHMS

(71) Applicant: Microsoft Technology Licensing, LLC, Redmond, WA (US)

(72) Inventors: Sanjeev Mehrotra, Kirkland, WA (US); Weidong Zhao, Bellevue, CA (US); Alex Filenkov, Redmond, WA (US); Costin Hagiu, Sammamish, WA (US)

(21) Appl. No.: 15/151,922

(22) Filed: May 11, 2016

(51) Int. Cl. H04L 12/801; H04L 12/26; H04L 12/851

(52) U.S. Cl. CPC H04L 47/127; H04L 47/24; H04L 43/0882; H04L 47/10

(57) ABSTRACT

A computing system manages communications congestion by selecting a transmission rate differently in different operating modes. In a delay-plus-loss mode, the transmission rate is selected as the lesser of a rate that would be selected by loss-based algorithm or by a delay-based algorithm. In a loss-based mode, the transmission rate is selected as the lesser of a rate that would be selected by loss-based algorithm, on one hand, and the maximum of a rate that would be selected by a delay-based algorithm or a rate proportional to the maximum estimated link rate divided by the number of data flows estimated to be competing for link bandwidth on the other hand. A database may be maintained of observations of network and link performance over time, where the database contains such information as the maximum estimated link rate capacity, minimum delays, and minimum losses.

### BACKGROUND

A wide and heterogeneous range of data travels across data networks such as the internet. Each application which sends flows of data may have different requirements in terms of required throughput, delay, and loss. The achieved network characteristics are a function of the network capacity, network conditions, other flows on the network and the congestion control methods, if any, being used by each network application.

### SUMMARY

A computing system manages communications congestion by selecting a transmission rate differently in different operating modes. In a delay-plus-loss mode, the transmission rate is selected as the lesser of a rate that would be selected by loss-based algorithm and by a delay-based algorithm. In a loss-based mode, the transmission rate is selected as the lesser of a rate that would be selected by loss-based algorithm, on one hand, and the maximum of a rate that would be selected by a delay-based algorithm or a rate proportional to the maximum estimated link rate divided by the number of data flows estimated to be competing for link bandwidth on the other hand.

A database may be maintained of observations of network and link performance over time, where the database contains such information as the maximum estimated link rate capacity, minimum delays, and minimum losses. In a learning mode, the system may observe and record the estimated link capacity rate, minimum delays, and minimum losses.

The system may transition from delay-plus-loss mode to the loss-based mode when there is a large reduction in the transmission rate in a short time span. Similarly, the system may transition from the loss-based mode to the delay-plus-loss mode when the rate that would be selected by a delay-based algorithm exceeds, by a factor, the maximum estimated link rate capacity divided by the estimated number of competing flows. The system may transition from the loss-based mode to the learning mode when the system has been too long in the loss-based mode. The system may transition from the learning mode when learning is complete, and may re-enter learning mode at random intervals to reassess network capacities.

This summary is provided to introduce a selection of concepts in a simplified form that are further described below in the detailed description. This summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

FIG. 1 is a block diagram of a collection of computing systems comprising computers, routers, a network, and various data links.

FIG. 2 is a system diagram of an example computer.

FIG. 3 is a state diagram showing three modes of operation of an example computing system, example transitions between modes of operation, and access to a database of network operations data available for access to, and update by, all three modes.

FIG. 4 is a flow diagram showing an example method of operating a computing system with multiple modes of operation, including criteria for transitions between modes and access to a database of network operations data.

### DETAILED DESCRIPTION

An effective rate control strategy may be achieved by automatically switching between delay-based and loss-based rate control through observation of channel properties and changing loss and delay conditions. A multi-mode approach, which combines delay-based and loss-based congestion control algorithms, may be useful, for example, to control communication rates for real-time interactive applications, which prefer delay-based rate control, when those real-time interactive applications are competing for communications link bandwidth with data flows that are utilizing loss-based rate control.

If a real-time application were to use only delay-based control, it may be difficult to obtain a fair share of the bandwidth when competing with one or more loss-based flows. Further, when using purely loss-based control, a real-time application would have poor performance due to increased congestion-induced queuing delay and loss.

These difficulties may be overcome using combined delay and loss based congestion control algorithms with multiple modes of operation. For example, an algorithm may be implemented by a system using a state machine with three communications rate setting modes: a learning mode, a delay-plus-loss mode, and a loss-based.

In the learning mode, the system observes network conditions and selects the next mode to use accordingly. In the delay-plus-loss mode, the transmission rate is selected as the lesser of a rate that would be selected by loss-based algorithm or by a delay-based algorithm. In the loss-based mode, the transmission rate is selected as the lesser of a rate that would be selected by loss-based algorithm, on one hand, and the maximum of a rate that would be selected by a delay-based algorithm or a rate proportional to the maximum estimated link rate divided by the number of data flows estimated to be competing for link bandwidth on the other hand.

A database may be maintained of observations of network and link performance over time, where the database contains such information as maximum estimated link rate capacities, minimum delays, and minimum losses. In a learning mode, the system may observe and record the estimated link capacity rate, minimum delays, and minimum losses.

The multi-mode algorithm includes conditions for transitioning between modes. Changes in observed delays or losses may be used to determine when a different mode will be more advantageous for the performance of the application. For example, the system may transition from delay-plus-loss mode to the loss-based mode when there is a large reduction in the transmission rate in a short time. Similarly, the system may transition from the loss-based mode to the delay-plus-loss mode when the rate that would be selected by a loss-based algorithm exceeds the maximum estimated link rate capacity divided by the estimated number of competing flows. The system may transition from the loss-based mode to the learning mode when the system has been too long in the loss-based mode. The system may transition from the learning mode when learning is compete, and may re-enter learning mode at random intervals to reassess network capacities.

Applications may generally be divided into real-time applications and non-real-time applications. Non real-time-applications are those where communication performance, and perhaps ultimate application performance, is determined primarily by average throughput. In these applications, the delay between when a sender generates a packet to when the receiver consumes the packet may be significantly larger than inherent network latencies without adversely impacting application performance. Examples include file-transfer protocol (FTP), non-interactive web traffic, and video-on-demand (VOD). For non-real-time applications often what matters most is how much information is transported, rather than precisely when it arrives. Congestion control protocols for non-real-time applications are often based on observed communications losses. I.e., the rate of transmission is determined by examining packet loss. Under such protocols, the transmission rate may be increased until the loss rate is above some threshold, which may occur when transmission backlogs exceed buffer capacities.

Real-Time applications are those where the application performance may be principally determined by throughput, delay, and loss. In these applications, generally the delay between when a sender generates a packet to when the receiver consumes the packet is on the order of inherent network latencies. Any network delays or losses may be critical to a user's experience of the application. Examples include VoIP, video conferencing, online-gaming, and interactive cloud applications. For real-time applications, congestion control protocols are preferably based on delay-based rate control, i.e. the rate of transmission is determined by examining packet delay.

Ideally, all the applications using a given network link would utilize compatible rate control algorithms to provide for easier coordination of fair sharing of the link. However, makers of non-real-time applications are unlikely to adopt the use of delay-based rate control algorithms, for example. Delay-based rate control algorithms may be significantly more difficult to implement than loss-based rate control algorithms. This is because delay is typically a noisier signal than packet loss. Further, delay-based rate control algorithms may result in lower throughput when competing with loss-based rate control algorithms. Thus for non-real-time applications, where performance is primarily determined by throughput, it is generally preferred to use loss-based rate control algorithms.

At the same time, the use of loss-based rate control algorithms by non-real-time applications may result in significant increases in congestion-induced packet loss and queuing delay on a link. This in turn results in poorer performance of real-time applications that share the network link. Congestion induced packet loss typically occurs at higher congestion levels than congestion induced queueing delay. Therefore, to maintain some share of channel capacity, an application which prefers delay-based flow may nonetheless benefit from using loss-based rate control when sharing a link on which other applications are using loss-based rate controls.

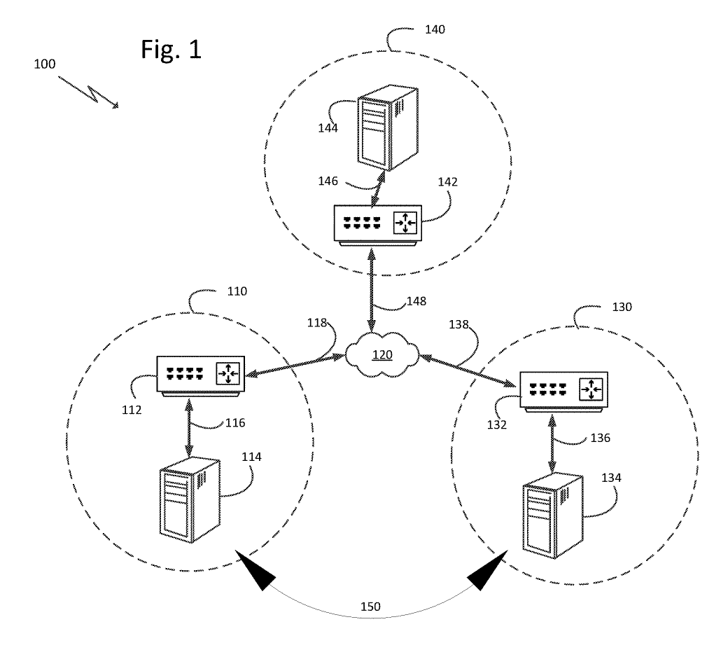

FIG. 1 shows a system 100 with computing devices at three locations 110, 130, and 140 connected by a computer network 120. Each location 110, 130, and 140 has a computer 114, 134, and 144, respectively, each running one or more applications. The computers include, for example, personal desktop, laptop, tablet, or mobile computers, other mobile digital devices, and gaming consoles. The applications may be real-time or non-real-time applications. Each computer 114, 134, and 144, is connected by a local network link 116, 136, and 146, to a set of switches and routers 112, 132, and 142, and then via an external link 118, 138, and 148, respectively to the network 120. Network 120 may be a local network, such as a LAN, a WAN, or the Internet, for example. The local network links 116, 136, and 146, and external network links 118, 138, and 148, may carry traffic in either direction for any number of applications. The traffic may be of any type, and be controlled by any congestion management algorithm.

For example, a real-time application running on computer 114 may use a link 150 to communicate with computer 134. Link 150 is physically implemented via local link 116 and local router 112 and external link 118 to the network 120, and then via the external link 138 down to router 132 and internal link 146 to computer 134. Throughput, loss, and delay on link 150 will be a function of the physical capacities of the component devices, the traffic flows thereon, and the congestion management algorithms implemented by the applications directing the traffic flows.

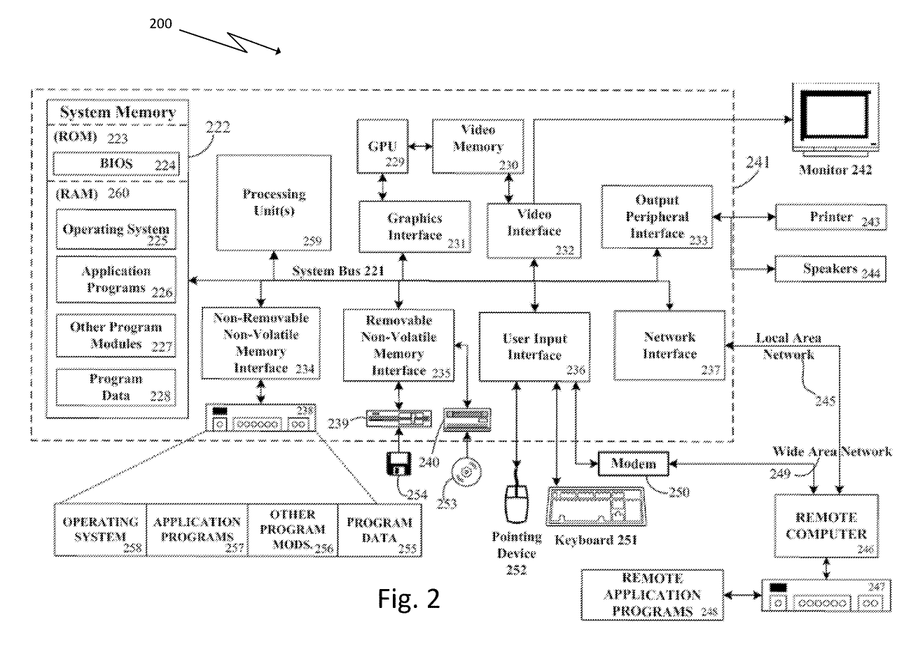

FIG. 2 illustrates an example of a computing environment 220 that may be used as one of the computers shown in FIG. 1. The computing environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the example computing environment 220. The various depicted computing elements may include circuitry configured to instantiate specific aspects of the present disclosure. For example, the term circuitry used in the disclosure may include specialized hardware components configured to perform function(s) by firmware or switches. In other examples the term circuitry may include a general purpose processing unit, memory, etc., configured by software instructions that embody logic operable to perform function(s). In examples where circuitry includes a combination of hardware and software, an implementer may write source code embodying logic and the source code may be compiled into machine readable code that may be processed by the general purpose processing unit. Since one skilled in the art may appreciate that the state of the art has evolved to a point where there is little difference between hardware, software, or a combination of hardware/software, the selection of hardware versus software to effectuate specific functions is a design choice left to an implementer. More specifically, one of skill in the art may appreciate that a software process may be transformed into an equivalent hardware structure, and a hardware structure may itself be transformed into an equivalent software process. Thus, the selection of a hardware implementation versus a software implementation is one of design choice and left to the implementer.

In FIG. 2, the computing environment 220 comprises a computer 241, which typically includes a variety of computer readable media. Computer readable media may be any available media that may be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 2 illustrates operating system 225, application programs 226, other program modules 227, and program data 228.

The computer 241 may also include other removable/non-removable, volatile/nonvolatile computer storage media. By way of example only, FIG. 2 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that may be used in the example operating environment include, but are not limited to, magnetic tape cassettes, flash memory cards, digital versatile disks, digital video tape, solid state RAM, solid state ROM, and the like. The hard disk drive 238 is typically connected to the system bus 221 through a non-removable memory interface such as interface 234, and magnetic disk drive 239 and optical disk drive 240 are typically connected to the system bus 221 by a removable memory interface, such as interface 235. For purposes of this specification and the claims, the phrase “computer-readable storage medium” and variations thereof, does not include waves, signals, and/or other transitory and/or intangible communication media.

The drives and their associated computer storage media provide storage of computer readable instructions, data structures, program modules and other data for the computer 241. In FIG. 2, for example, hard disk drive 238 is illustrated as storing operating system 258, application programs 257, other program modules 256, and program data 255. Note that these components may either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, which may take the form of a mouse, trackball, or touch pad, for instance. Other input devices (not shown) may include a microphone, joystick, game pad, satellite dish, scanner, or the like. These and other input devices are often connected to the processing unit 259 through a user input interface 236 that is coupled to the system bus 221, but may be connected by other interface and bus structures, such as a parallel port, game port or a universal serial bus (USB). A monitor 242 or other type of display device is also connected to the system bus 221 via an interface, such as a video interface 232, which may operate in conjunction with a graphics interface 231, a graphics processing unit (GPU) 229, and/or a video memory 229. In addition to the monitor, computers may also include other peripheral output devices such as speakers 244 and printer 243, which may be connected through an output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 2. The logical connections depicted in FIG. 2 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 2 illustrates remote application programs 248 as residing on memory device 247. It will be appreciated that the network connections shown are examples and other means of establishing a communications link between the computers may be used.

Herein, algorithms and devices are described in terms of controlling the transmission rate R, which is the number of bits or bytes to be transmitted in some given unit of time, by a given computer application. It will be appreciated that such algorithms and devices may equally be described as controlling the window, W, which is the maximum number of bits or bytes in flight that can be outstanding, i.e., that have not yet been acknowledged or declared to be lost. A simple approximation between the two can be given W≈R*SRTT, where SRTT is a smoothed version of the current round-trip time RTT.

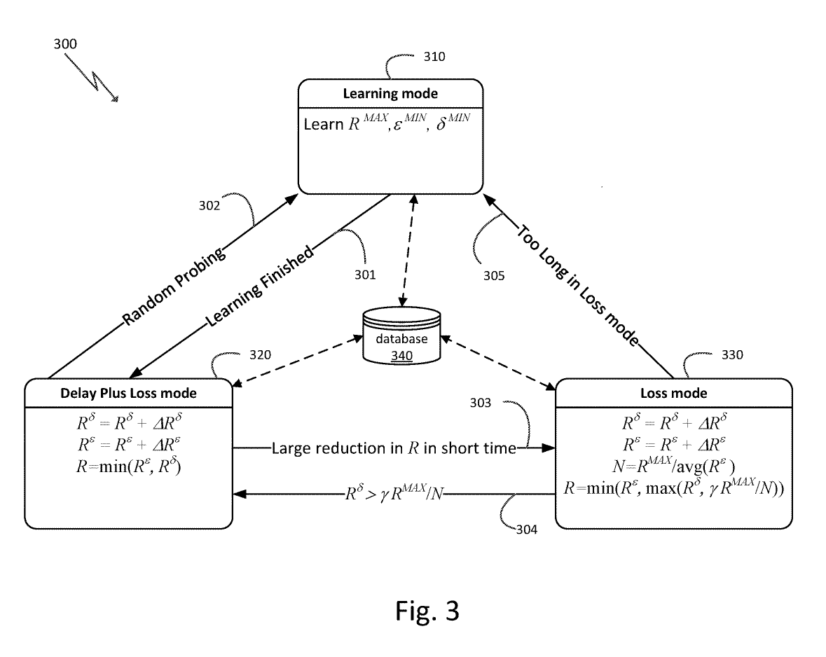

FIG. 3 shows a state diagram with three modes of operation of an example combined delay-plus-loss and loss-based congestion management algorithm 300 that may be used by a system to determine a variety communications rates to be used at different times by an application. The three modes are a learning mode 310, a delay-plus-loss mode 320, and a loss-based mode 330. In the delay-plus-loss mode 320 and loss-based mode 330, both a suggested transmission rate based on losses and a suggested transmission rate based on delays are computed. Further calculations are then performed to determine the final transmission rate R that is used. For example, the final transmission rate may be the lesser of the two suggested rates.

In learning mode 310, the system observes network properties and conditions. The transitions 301-305 denote times when the system will switch from using one mode to another. All modes may inform, and be informed by, a database 340 containing records of observed network properties, e.g., estimates of maximum link data carrying capacities, and minimum expected link losses and delays. R^{MAX}, δ^{MIN}, and ε^{MIN}, may be determined from network observations in learning mode 310. The delay-plus-loss mode 320 and loss mode 330 may similarly inform, and be informed by, the database 340, whereby data from the database 340 is used to initialize operation of each mode and to store observations made during each mode.

When learning is complete, the algorithm 300 may follow transition 301 to switch to the delay-plus-loss mode 320. Learning mode 310 may be invoked by any other mode. For example, the delay-plus-loss mode 320 may reinitiate the learning mode 310, following transition 302, at random intervals. Similarly, the loss-mode 330 may initiate the learning mode 310, following transition 305, upon the expiration of a watchdog time, for instance. Alternatively, learning may continue in the background of the other modes at all times.

During learning mode, congestion signals are not used to control the rate R. To obtain an estimate of δ^{MIN}, and ε^{MIN}, the transmission rate is set to a very low rate which is known with high probability not to cause network congestion. The observed queuing delay and loss are assumed to be inherent to the network and are the values for δ^{MIN}, and ε^{MIN} respectively. To obtain an estimate of R^{MAX}, the transmission rate is set to a very high rate which is known with high probability to cause congestion. The estimate of the received rate is the value for the estimated R^{MAX}.

A system, such as a computer application, that is operating in a delay-plus-loss mode 320 may compute a first transmission rate based on delays, a second rate based on losses, and then select one of these rates as the rate to be used. Let R^{δ} be the transmission rate suggested by a rate controller which uses a congestion control algorithm based on observed queuing delay, and ΔR^{δ} be the suggested change in transmission rate based on delay. Similarly, let R^{ε} be the rate given by a rate controller which responds to loss data, and ΔR^{ε} be the suggested change in rate based on loss.

In delay-plus-loss mode 320, R may be selected by first assigning present values of R^{δ} and R^{ε} to be equal to prior values plus suggested deltas, and then selecting the minimum of the two suggested rates, according to the following equations:

R^{δ}:=R^{δ}+ΔR^{δ} Equation 1

R^{ε}:=R^{ε}+ΔR^{ε} Equation 2

R:=min(R^{δ}, R^{ε}) Equation 3

If a loss-based flow, such as a TCP flow, is introduced somewhere on the link being used by the application, the delay seen by the application will likely increase. This is because a loss-based flow will fill the buffer of the router on the bottleneck link, i.e., until packets are lost because they cannot be buffered. If the router buffer is large, a large delay will be seen, and the rate will be low. For example, consider a rate controller which utilizes the following rate control adjustment in response to queuing delay:

R^{δ}:=R^{δ}+k₂(k₀−δR^{δ)} Equation 4

In Equation 4, δ is the queueing delay and k₀ is the number of bits sent at the operating point. In steady state, the rate of bits sent R will be equal to the parameter k₀ over the delay, as given here:

$$R = \frac{{k}_{0}}{δ} \qquad Equation 5$$

If the capacity of the link is 1 Mbps, and there are two delay-based flows which have the same k₀ of 5000 bits, each flow with have a rate of will be 500 kbps, with a steady state queueing delay of 10 ms.

However, now if one of the two flows is a loss-based flow, such as a TCP flow, the situation will be different. A TCP flow will fill the buffer completely. If the router buffer is 200 ms in length, with the same k₀, the delay-based flow only get 25 kbps, and the TCP flow will get 975 kbps.

The arrival of a competing loss-based flow may be sensed by the application, e.g., as a large reduction of R in a short time. Similarly, the presence of one more or more competing loss-based loss based flows may be inferred from receiving a small share of the link capacity. If the application is aware that the maximum link rate is close to 1 Mbps, and that the application is currently achieving a throughput of 25 kbps, i.e., 2.5% of the maximum, it is probable that a TCP flow is clogging a buffer. In such cases, the algorithm may follow transition 303 switch to its own the loss-based mode 330.

In the loss-based mode 330, R^{δ} and R^{ε} are again computed separately based observed delay and loss, respectively. The transmission rate R is computed as follows:

$$R := min ( {R}^{ε} , max ( {R}^{δ} , γ \frac{{R}^{MA X}}{N} ) ) \qquad Equation 6$$

Where R^{MAX} is an estimate of the maximum link rate, and N is defined as follows:

$$N := \frac{{R}^{MA X}}{avg ( {R}^{ε} )} . \qquad Equation 7$$

Here avg(R^{ε}) is the average rate reported by the loss based controller over some time window. γ is some constant less than 1, e.g., between 0.5 and 1. Typically γ is set close to one, e.g., γ=0.9. N is an estimate of the number of flows present. A default value of N=1 may be used initially. If no competing flows are estimated to be present, i.e., the flow from the application is expected to be the only flow on the link, N=1, and thus:

R=min(R^{ε}, max(R^{δ}, γR^{MAX}))=min(R^{ε}, γR^{MAX})≈R^{ε} Equation 8

This setting allows the flow managed by the algorithm 300 to compete effectively with a TCP flow. If there is one competing flow, N will converge to around two, and the rate we can achieve will be close to

$$\frac{γ}{2} {R}^{MA X} \approx 0.45 {R}^{MA X}$$

for γ=0.9. This may be viewed as an approximate fair sharing of the contested resource. With M competing flows and L of flows under the control of algorithm 300, N converges to approximately M+L. Then, the R rate determined by loss-based mode 330 is:

$$R = min ( {R}^{ε} , max ( {R}^{δ} , \frac{{γR}^{MA X}}{M + L} ) ) \approx \frac{{γR}^{MA X}}{M + L} \qquad Equation 9$$

This again is desirable. When the competing flows depart, N will start approaching L. However, since

$$\begin{matrix}N = \frac{{R}^{MA X}}{avg ( {R}^{ε} )} & Equation 10 \\ R = min ( {R}^{ε} , max ( {R}^{δ} , γavg ( {R}^{ε} ) ) ) \approx γavg ( {R}^{ε} ) & Equation 11\end{matrix}$$

If the averaging of R^{ε} is done over a sufficiently long duration, then R will stay below R^{E} for a sufficient duration of time for the queues to clear. Therefore, R^{δ} will start increasing and will eventually surpass γ(avg(R^{ε})). At this point, algorithm 300 may follow transition 304 to switch back to delay-plus-loss mode 320.

An alternative is to allow N to only increase during the loss-based mode. This guarantees convergence back to the delay-plus-loss mode. If we only allow N to increase, then essentially we can write it as

$$N := min ( N , \frac{{R}^{MA X}}{avg ( {R}^{ε} )} )$$

every time R^{ε} updates.

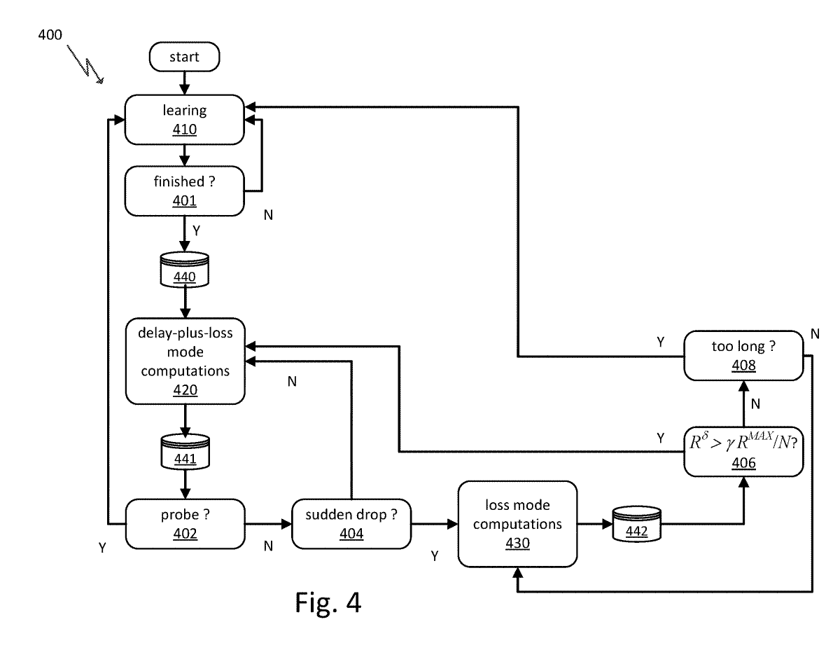

FIG. 4 is a flow diagram showing an example method 400 of operating a computing system with multiple modes of operation, including criteria for transitions between modes and access to a database of network operations data. The modes, computations, operations, and transitions in FIG. 4 accord with those described in reference to FIG. 3, with the purpose of controlling a transmission rate of communications to optimize performance of a computing application sending or receiving such communications.

In the example of FIG. 4, the method begins with the optional learning mode 410 where characteristics of one or more networks or network links are observed. In step 401, a determination is made as to whether sufficiently information has been gathered, e.g., acquired within a reasonable time or within a reasonable degree of confidence. If not, learning continues.

When learning is complete, in step 440 the results may be recorded in a database. This may include such parameters as maximum throughput, minimum delay, and minimum loss, along with the time, date, and other conditions under which the observations were made.

Next, in step 420, the system enters delay-plus-loss mode 420, and operates according to the Equations 1-3 as described for this mode in connection to FIG. 3. After computing a transmission rate, the system may record its observations to the database in step 441. In step 402 the system may further check whether to reinitiate learning mode 410, e.g., in response to a periodic timer or at random. In step 404, the system checks whether it may be likely to achieve better performance in loss-based mode 430. For example, the system may check whether the computed transmission rate has fallen rapidly, e.g., due to rapidly rising packet loss which may be due to the arrival of a competing, loss-based flow such as a TCP data flow. If a determination to switch modes is reached in step 404, the system switches to loss-based mode 430. Otherwise, the system returns to delay-plus-loss mode 420 to re-compute a transmission rate in accordance with current network conditions.

In loss-based mode 430, the system operates according to the Equation 6 described for this mode in connection to FIG. 3. After computing a transmission rate, again the system may record its observations to the database in step 442.

In step 406, the system checks whether it may be likely to achieve better performance in delay-plus-loss based mode 420. For example, the system may check whether R^{δ} exceeds γ(avg(R^{ε})). This may be the case, for example, when a previously competing loss-based flow, such as a TCP data flow, is no longer contributing to losses along a shared network link. If a determination to switch modes is reached in step 406, the system switches to delay-plus-loss based mode 420.

In step 408 the system may further check whether to reinitiate learning mode 410, e.g., in response to a periodic timer or at random. Otherwise, the system returns to loss based mode 420 to re-compute a transmission rate in accordance with current network conditions.

The methods described herein may be implemented in a variety of ways on a variety of computing equipment. For example, a computing system may be configured to determine a final communications transmission rate to be used to send a flow over a shared network link, where the computing system comprises a processor and a memory storing thereon computer-executable instructions, the computing system being configured such that, when executed by the processor, the computer-executable instructions cause the computing system to perform one or more of the methods described herein in reference to FIGS. 3 and 4 and Equations 1 to 11. The computing system may, for example, be the system depicted in FIG. 2 and operate in the environment of FIG. 1.

The methods implemented by the computing system may include: computing a first transmission rate based on observed communication delays; computing a second transmission rate based on observed communications losses; estimating a number of competing flows from an estimated link capacity rate divided by the second rate; in a first mode, determining the final rate as the minimum of the first rate and the second rate; and in a second mode, determining a third rate as the estimated link capacity rate divided by the estimated number of competing flows times a factor between 0.5 and 1, determining a fourth rate as the maximum of first rate and the third rate, determining the final rate as the minimum of the second rate and the fourth rate.

The observed communication delays and losses, and the estimated link capacity, may be drawn from current observation of network conditions. Alternatively these measurements may be drawn from a stored record of prior observations of network performance, or derived based on current conditions and prior observations.

The method may include transitioning from the first mode to the second mode when the final rate drops more rapidly than a predetermined performance shift rate. For example, a threshold may be set at 20% per second. If the final rate drops more than 20% in one second, the system may transition from the first mode to the second mode. The exact performance shift rate used as a threshold may be determined empirically, e.g., through observation of network performance over time. Alternatively, the performance shift rate may be a factory setting in the system. Further, the performance shift rate may be determined experimentally, e.g., by injecting a test TCP along the same being used by the application utilizing the system to set the communications rate, or simply by testing performance with various rate settings.

The method may include transitioning from the second mode to the first mode when the first rate is greater than the third rate. The method may include a third mode, which is a learning mode that includes observing the estimated link capacity rate, a minimum link loss, and a minimum link delay, and storing a second record comprising the estimated link capacity rate, the minimum link loss, and the minimum link delay. The method may include transitioning from the second mode to the third mode when a period of time operating in in loss-based mode exceeds a predetermined maximum period. For example, if the system has been operating in the loss-based mode for more than 30 seconds, it may automatically switch over to the learning mode. Similarly, the method may include transitioning from the third mode to the first mode when learning is completed. Further, the method may include transitioning from the first mode to the third mode at a random interval. For example, the system may switch to learning mode at a random interval between 1 and 120 minutes.

We claim:

1. A method for controlling a final communications transmission rate to be used by a computer to send a flow over a shared network link, comprising:
computing a first transmission rate based on observed communication delays in the shared network link;
computing a second transmission rate based on observed communications losses in the shared network link;
estimating a number of competing flows from an estimated link capacity rate divided by the second rate;
in a first mode, determining the final rate as the minimum of the first rate and the second rate; and
in a second mode:
determining a third rate as the estimated link capacity rate divided by the estimated number of competing flows times a factor between 0 and 1,
determining a fourth rate as the maximum of first rate and the third rate;
determining the final rate as the minimum of the second rate and the fourth rate; and
controlling the final communications transmission rate to send the flow over the shared network link using the final rate.

2. The method of claim 1, further comprising transitioning from the first mode to the second mode when the final rate drops more rapidly than a predetermined performance shift rate.

3. The method of claim 1, further comprising transitioning from the second mode to the first mode when the first rate is greater than the third rate.

4. The method of claim 1, further comprising, in a third mode, observing the estimated link capacity rate.

5. The method of claim 1, further comprising transitioning from the second mode to the third mode when a period of time operating in in loss-based mode exceeds a predetermined maximum period.

6. The method of claim 1, further comprising transitioning from the third mode to the first mode when learning is completed.

7. The method of claim 1, further comprising transitioning from the first mode to the third mode at a random interval.

8. A method for determining a final communications transmission rate to be used by a computer application to send a flow over a shared network link, comprising:
computing a first transmission rate based on observed communication delays;
computing a second transmission rate based on observed communications losses;
estimating a number of competing flows from an estimated link capacity rate divided by the second rate, where the estimated link capacity is drawn from a first record of a prior observed link capacity;
in a first mode, determining the final rate as the minimum of the first rate and the second rate; and
in a second mode:
determining a third rate as the estimated link capacity rate divided by the estimated number of competing flows times a factor between 0 and 1:
determining a fourth rate as the maximum of first rate and the third rate;
determining the final rate as the minimum of the second rate and the fourth rate; and
controlling the final communications transmission rate to send the flow over the shared network link using the final rate.

9. The method of claim 8, further comprising transitioning from the first mode to the second mode when the final rate drops more rapidly than a predetermined performance shift rate.

10. The method of claim 8, further comprising transitioning from the second mode to the first mode when the first rate is greater than the third rate.

11. The method of claim 8, further comprising, in a third mode, observing the estimated link capacity rate, a minimum link loss, and a minimum link delay, and storing a second record comprising the estimated link capacity rate, the minimum link loss, and the minimum link delay.

12. The method of claim 8, further comprising transitioning from the second mode to the third mode when a period of time operating in in loss-based mode exceeds a predetermined maximum period.

13. The method of claim 8, further comprising transitioning from the third mode to the first mode when learning is completed.

14. The method of claim 8, further comprising transitioning from the first mode to the third mode at a random interval.

15. A computing system for determining a final communications transmission rate to be used to send a flow over a shared network link, comprising
a processor and a memory storing thereon computer-executable instructions,
the computing system being configured such that, when executed by the processor, the computer-executable instructions cause the computing system to:
compute first transmission rate based on observed communication delays;
compute a second transmission rate based on observed communications losses;
estimate a number of competing flows from an estimated link capacity rate divided by the second rate;
in a first mode, determine the final rate as the minimum of the first rate and the second rate; and
in a second mode:
determine a third rate as the estimated link capacity rate divided by the estimated number of competing flows times a factor between 0 and 1:
determine a fourth rate as the maximum of first rate and the third rate;
determine the final rate as the minimum of the second rate and the fourth rate; and
control the final communications transmission rate to send the flow over the shared network link using the final rate.

16. The computing system of claim 15, wherein the computer-executable instructions further cause the computing system to transition from the first mode to the second mode when the final drops more rapidly than a predetermined performance shift rate.

17. The computing system of claim 15, wherein the computer-executable instructions further cause the computing system to transition from the second mode to the first mode when the first rate is greater than the third rate.

18. The computing system of claim 15, wherein the computer-executable instructions further cause the computing system to, in a third mode, observing the estimated link capacity rate.

19. The computing system of claim 15, wherein the computer-executable instructions further cause the computing system to transition from the second mode to the third mode when a period of time operating in in loss-based mode exceeds a predetermined maximum period.

20. The computing system of claim 15, wherein the computer-executable instructions further cause the computing system to transition from the third mode to the first mode when learning is completed.
